(19) United States
(12) Patent Application Publication
(10) Pub. No.: US 2021/0107681 A1
(43) Pub. Date: Apr. 15, 2021

(54) SENSOR ASSEMBLY AND UNMANNED AERIAL VEHICLE

(71) Applicant: SZ DJI TECHNOLOGY CO., LTD., Shenzhen (CN)

(72) Inventors: Rongming XIONG, Shenzhen (CN); Yin TANG, Shenzhen (CN); Xianwu XIONG, Shenzhen (CN); Deng WANG, Shenzhen (CN)

(21) Appl. No.: 17/129,361

(22) Filed: Dec. 21, 2020

Related U.S. Application Data
(63) Continuation of application No. PCT/CN2018/092938, filed on Jun. 26, 2018.

(51) Int. Cl. B64D 47/08; B64C 39/02

(52) U.S. Cl. CPC B64D 47/08; B64C 2201/127; B64C 39/024

(57) ABSTRACT

A sensor assembly for an unmanned aerial vehicle (UAV) includes a binocular sensor. The binocular sensor includes two vision sensors. The two vision sensors are located at a same vertical plane. The two vision sensors are arranged one above another at an interval.

### CROSS-REFERENCE TO RELATED APPLICATION

This application is a continuation of International Application No. PCT/CN2018/092938, filed Jun. 26, 2018, the entire content of which is incorporated herein by reference.

### TECHNICAL FIELD

The present disclosure relates to the aerial vehicle field and, more particularly, to a sensor assembly and an unmanned aerial vehicle.

### BACKGROUND

With the development of technology, smart devices such as unmanned aerial vehicles (UAVs) have been applied in various fields.

Currently, a smart device needs to rely on a sensor device such as a vision sensor to detect an external environment when automatically executing a task. A binocular sensor includes two cameras arranged horizontally at an interval, thus, the binocular sensor obtains three-dimensional information of a surrounding environment or a to-be-detected object through a plurality of images by using a visual difference between the cameras at different positions, for example, a distance between the smart device and the object, to perform a thorough and reliable sensor detection. A detection distance of the binocular sensor is related to an interval between the two cameras. To form a relatively far detection distance, the two cameras are maintained at a relatively far interval.

However, since an arm and a propeller of the UAV are located at a side of the UAV, these structures are close to the cameras of the binocular sensor in a horizontal direction, which may easily block the cameras. As such, an obstacle avoidance distance is large.

### SUMMARY

Embodiments of the present disclosure provide a sensor assembly for an unmanned aerial vehicle (UAV) including a binocular sensor. The binocular sensor includes two vision sensors. The two vision sensors are located at a same vertical plane. The two vision sensors are arranged one above another at an interval.

### BRIEF DESCRIPTION OF THE DRAWINGS

FIG. 1 is a schematic structural diagram of a sensor assembly according to some embodiments of the present disclosure.

FIG. 2 is a schematic partial enlarged view of part A in FIG. 1.

FIG. 3 is a schematic exploded view of the sensor assembly according to some embodiments of the present disclosure.

FIG. 4 is a schematic structural diagram showing a support member of the sensor assembly according to some embodiments of the present disclosure.

FIG. 5 is a schematic structural diagram showing a flexible sleeve of the sensor assembly according to some embodiments of the present disclosure.

FIG. 6 is a schematic structural diagram of an unmanned aerial vehicle (UAV) according to some embodiments of the present disclosure.

### REFERENCE NUMERALS

1—Binocular sensor; 2—Vehicle body; 3—Sensor; 4—Vehicle arm; 5—Power assembly; 11, 11a, 11b—Vision sensor; 12—Support member; 13—Fixing member; 14—Flexible sleeve; 21—Threaded hole; 22—First lens hole; 23—Second lens hole; 31—First sensor; 32—Second sensor; 121—First fixing slot; 122—Fixing portion; 123—Second fixing slot; 131—Stopper; 132—Connector; 141—Second through-hole; 141—Snap protrusion; 1221—First through-hole; 1222—Snap slot; 100—Sensor assembly; 200—UAV.

### DETAILED DESCRIPTION OF THE EMBODIMENTS

To make purposes, technical solutions, and advantages of embodiments of the present disclosure clearer, the technical solutions of embodiments of the present disclosure are described in detail in connection with the accompanying drawings of embodiments of the present disclosure. Described embodiments are some embodiments of the present disclosure but not all embodiments. Based on embodiments of the present disclosure, all other embodiments obtained by those of ordinary skill in the art without creative efforts are within the scope of the present disclosure.

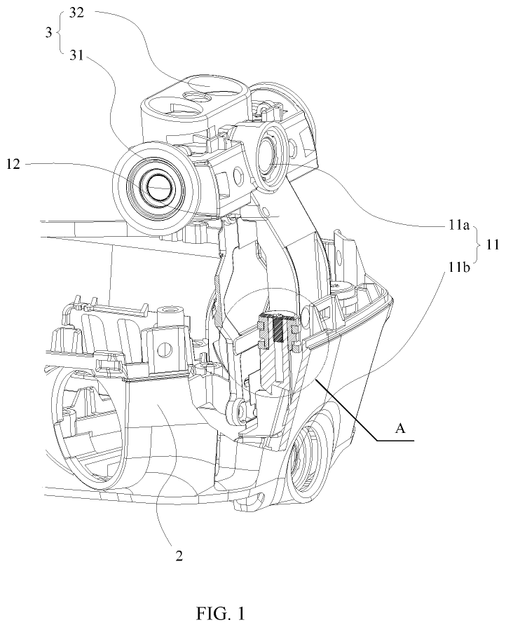

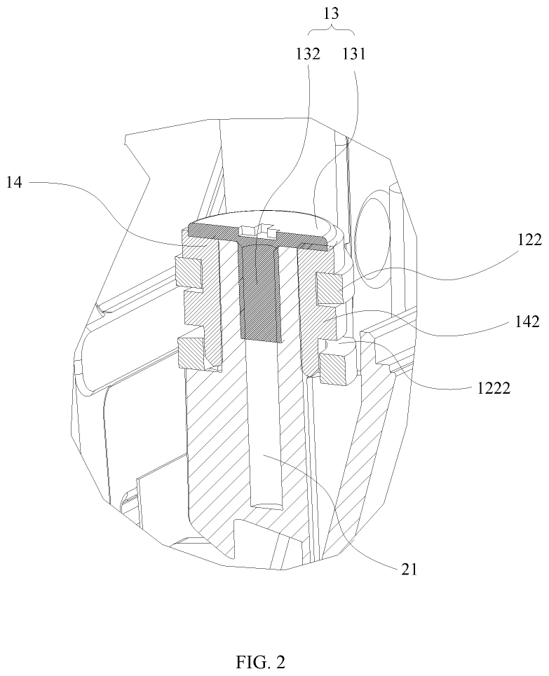

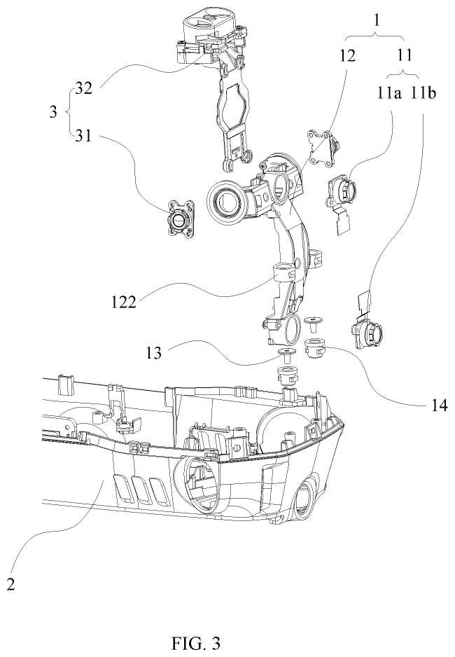

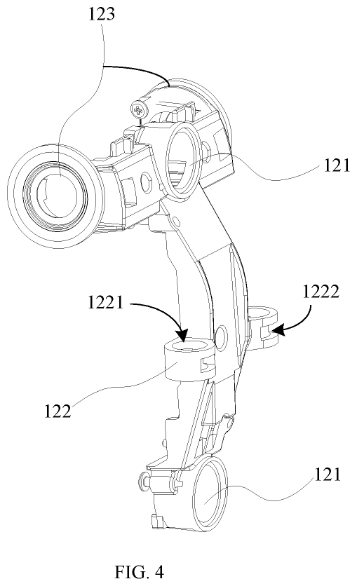

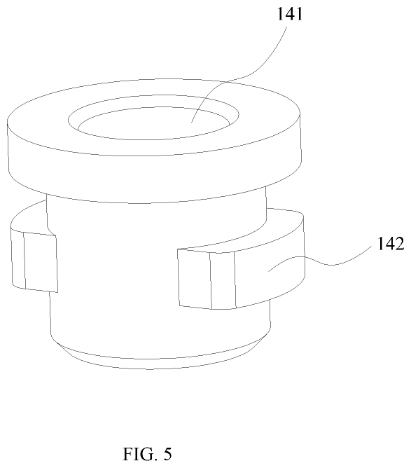

FIG. 1 is a schematic structural diagram of a sensor assembly according to some embodiments of the present disclosure. FIG. 2 is a schematic partial enlarged view showing part A in FIG. 1. FIG. 3 is a schematic exploded view of the sensor assembly according to some embodiments of the present disclosure. FIG. 4 is a schematic structural diagram showing a support member of the sensor assembly according to some embodiments of the present disclosure. FIG. 5 is a schematic structural diagram showing a flexible sleeve of the sensor assembly according to some embodiments of the present disclosure. The sensor assembly shown in FIGS. 1-5 can be applied to an unmanned aerial vehicle (UAV). The sensor assembly includes a binocular sensor 1. The binocular sensor 1 includes two vision sensors 11 (i.e., 11a and 11b), which may obtain images individually. The two vision sensors 11a and 11b are located in a same vertical plane. The two vision sensors 11a and 11b are arranged up and down at an interval, which are close to an upper end and a lower end of the UAV, respectively.

In some embodiments, during flight, the UAV may need to measure and determine a distance between the UAV and a surrounding obstacle to prevent the close-by obstacle to disturb the flight of the UAV or the UAV even from hitting the obstacle. To measure the distance between the UAV and the surrounding obstacle, the sensor assembly may be arranged at the UAV to realize operations of distance measurement, obstacle avoidance, etc., by using the sensors. A variety of sensors may be used to measure the distance, for example, the vision sensor may be usually used to measure the distance of the obstacle.

To measure the distance through the vision sensor, the sensor assembly includes the binocular sensor 1. The binocular sensor may photograph and detect the object by using the two vision sensors 11a and 11b arranged at an interval. As such, the images photographed by the two vision sensors 11a and 11b may be processed comprehensively according to a distance difference and an angle difference between the two vision sensors to calculate the distance between the photographed object and the UAV. The vision sensor 11 may be usually a sensor capable of collecting an image such as a camera.

To realize the flight of the UAV in the air, the UAV may usually include a vehicle arm and a power assembly. The UAV may realize take-off and landing and normal flight by power generated by a propeller of the power assembly. Vehicle arms and power assemblies may be located at both sides of the UAV. Thus, when the vision sensors are close to the two sides of the UAV, the vehicle arm and the propeller may block or cover a viewing angle of a lens of the vision sensor 11. As such, the image collected by the vision sensor 11 may be incomplete, which may affect the accurate determination of a special feature of the photographed object to result in inaccurate distance measurement. In some embodiments, to prevent the viewing angle of the lens of the vision sensor from being blocked by other structures of the UAV, the binocular sensor 1 may not be arranged left and right, but the two vision sensors 11a and 11b may be arranged at the same vertical plane up and down at an interval. Further, the vision sensor s11a and 11b may be close to an upper end and a lower end of the UAV, respectively. Since the two vision sensors 11a and 11b are arranged up and down, a relatively large distance may be maintained between the vision sensors 11a and 11b to ensure that the binocular sensor 1 to have a sufficient detection distance. Further, the vision sensors 11a and 11b may be arranged at an area away from the center axis of the propeller of the UAV. As such, a distance between the vision sensors 11a and 11b and the propeller may be relatively large, which may effectively reduce blocking of the viewing angle of the lens of the vision sensors 11a and 11b by the propeller to ensure normal photographing and image collection by the vision sensors 11a and 11b.

In some embodiments, to ensure that both the vision sensors 11a and 11b of the binocular sensor 1 have relatively large distances to a blocking structure such as the propeller, both the two vision sensors 11a and 11b may be located at a longitudinal symmetry plane of the UAV.

The UAV includes a left-right symmetry structure to ensure stability during flight. As such, the UAV may include a symmetry plane in a longitudinal direction, that is, in a direction that the UAV flies forward. The symmetry plane includes the same distance to vehicle arms and propellers on both sides of the UAV. Therefore, both the vision sensors 11a and 11b of the binocular sensor 1 may be arranged at the longitudinal symmetry plane of the UAV. Thus, the vision sensors 11a and 11b may have the same distance to the left and right propellers of the UAV. That is, the vision sensors 11a and 11b may maintain the same distance to the propellers at any side of the UAV. Thus, the distance is a maximum distance that the vision sensors 11a and 11b may have to the propellers at the sides of the UAV, and the propellers may block the viewing angle of the lens of the vision sensor 11 at this position the least. If the vision sensor 11 is located at another position not on the longitudinal symmetry plane, the propeller at one side of the UAV may have a distance to the vision sensor 11 smaller than the maximum distance, thus, the propeller may block a larger area of the viewing angle of the lens.

In some embodiments, to realize normal distance measurement of the binocular sensor 1, both the vision sensors 11a and 11b may face the same direction. As such, both the vision sensors 11a and 11b may perform detection toward a same side of the UAV, and both the vision sensors 11a and 11b may detect the object and scene image in a same direction. The three-dimensional information of the object and the scene in this direction may be obtained by using differences between the images obtained by the two vision sensors 11a and 11b to realize a subsequent operation such as the distance measurement.

Optical axis directions of the vision sensors 11a and 11b may be completely the same or have a certain angle therebetween. In some embodiments, the optical axes of the two vision sensors 11a and 11b may be parallel to each other. As such, the two vision sensors 11a and 11b may obtain images from the same angle, and the only difference is that a certain distance difference may exist between the two vision sensors 11a and 11b. Thus, subsequent image processing may be simplified, which is beneficial to obtaining distance information between the UAV and the to-be-detected object quickly and reliably.

In addition, when the vision sensors 11a and 11b of the binocular sensor 1 are at the same vertical plane, the vision sensors 11a and 11b may face different directions within the vertical plane. As such, the binocular sensor 1 may perform the detection at different heights. In some embodiments, an optical centerline between the two vision sensors 11a and the 11b may be caused to have an angle to a horizontal plane.

In some embodiments, optical centers of the vision sensors 11a and 11b may be geometric center positions of the optical lenses of the vision sensors 11a and 11b. When the line connecting the optical centers (also referred to as an “optical centerline”) of the two vision sensors 11a and 11b is not parallel to the horizontal plane but has a certain angle to the horizontal plane, directions that the two vision sensors 11a and 11b face may not be above or below the sensor assembly but inclined toward the horizontal direction. As such, the binocular sensor 1 may perform detection and distance measurement on the object at the side. The directions that the vision sensors 11a and 11b of the binocular sensor 1 face may be determined by the size of the angle between the optical centerline and the horizontal plane.

Further, as a vision sensor arrangement manner, the optical centerline of the vision sensors 11a and 11b may be maintained to be perpendicular to the horizontal plane. Thus, not only the vision sensors 11a and 11b may be at the same vertical plane, but also the positions of the two vision sensors may overlap with each other along the up and down direction. Thus, since the optical centerline of the vision sensors 11a and 11b is along the vertical direction while the vision sensors 11a and 11b face the horizontal direction, the vision sensors 11a and 11b may detect an object directly in front of the binocular sensor 1 to complete a distance measurement task in most flight statuses of the UAV.

In some embodiments, to connect and fix the vision sensor 11, in some embodiments, the sensor assembly further includes a support member 12. The support member 12 may be arranged at the UAV and may be configured to fix the vision sensor 11. Thus, when the sensor assembly is fixed at the vehicle body 2 of the UAV, since the vision sensor 11 is arranged at the support member 12, once the support member 12 is fixed at the vehicle body 2, the sensor assembly can be positioned.

In some embodiments, to fix the vision sensor 11 at the support member 12, a first fixing slot 121 configured to fix the vision sensor 11 may be arranged at the support member 12. As such, the vision sensor 11 may be accommodated in the first fixing slot 121 to be fixed. The shape of the first fixing slot 121 may match the shape of the vision sensor 11. For example, the first fixing slot 121 may be formed as a chamber with one side open and the other side closed to accommodate the vision sensor 11 in the chamber.

In some embodiments, since the relative position and relative angle between the two vision sensors 11a and 11b need to maintain relatively high accuracy, the support member 12 may usually be an individual structural member. As such, the vision sensor 11 may be positioned by using the rigidity of the support member 12, and the relative position and the relative angle between the two vision sensors 11a and 11b may be relatively accurate.

In addition, to prevent the supporting 12 from generating deformation that may affect the relative position of the vision sensors 11a and 11b, the support member 12 may be made of a material with relatively high rigidity. For example, the support member 12 may be made of a metal material such as aluminum alloy.

When being fixed at the vehicle body 2 of the UAV, the support member 12 may be usually fixed by a snap connection or a threaded connection. Thus, a certain displacement or deformation may be generated between the support member 12 and the vehicle body 2 due to stress (stress of the threaded connection or stress generated during the snap connection and abutting) generated when the support member 12 is mounted at the vehicle body 2. The displacement and the deformation may affect the support member 12 to cause the support member 12 to generate a certain deformation. As such, the relative position and angle may change between the two vision sensors 11a and 11b at the support member 12. Moreover, the normal flight vibration generated when the UAV is in flight may be transferred to the support member 12 through the vehicle body 2 to affect the vision sensor 11 at the support member 12. Therefore, to avoid a negative impact generated due to the mounting stress or flight vibration of the UAV 2 on the vision sensor 11 and ensure the binocular sensor 1 to work reliably, in some embodiments, the support member 12 of the sensor assembly may be flexibly connected to the vehicle body 2 of the UAV. Through a flexible connection, the mounting stress of the support member 12 may be reduced, and the vibration from the vehicle body 2 may be filtered. As such, the relative position and the relative angle between the vision sensors 11a and 11b fixed at the support member 12 may be maintained to be accurate.

In some embodiments, the flexible connection between the support member 12 and the vehicle body 2 may be realized through one of a plurality of manners. For example, a vibration-damping member, a vibration-damping structure, etc., may be arranged between the support member 12 and the vehicle body 2. As one of the flexible connection manners, the sensor assembly may include a flexible connector. The flexible connector may be connected between the support member 12 and the vehicle body 2 of the UAV.

In some embodiments, the flexible connector may generate a certain elastic deformation to offset or absorb a portion of the mounting stress or the flight vibration from the vehicle body 2 of the UAV by the elastic deformation. To generate the elastic deformation, the flexible connector may include a structure that may generate the elastic deformation or may be made of a flexible material.

In some embodiments, to fix the support member 12 at the vehicle body 2 by the flexible connector, the support member 12 includes a fixing portion 122. The fixing portion 122 may be configured to be connected to the vehicle body 2 of the UAV by the flexible connector. In some embodiments, the fixing portion 122 may be a protrusion structure protruding from the surface of the body of the support member 12, or a positioning slot or an accommodation chamber arranged at the support member 12. Thus, the flexible connector may be mounted at the support member 12 by the fixing portion 122 and connected to the vehicle body 2.

In some embodiments, as one of the arrangement manners of the support member and the fixing portion, the two vision sensors 11a and 11b may be arranged at two ends of the support member 12, respectively. The fixing portion 122 may be located at the center section of the support member 12. Thus, the support member 12 may include a shape of a fixing beam or fixing rod having a certain length, and the two vision sensors 11a and 11b may be arranged at the upper and lower ends of the support member 12. The fixing portion 122 of the support member 12 may be connected to the vehicle body of the UAV by the flexible connector. As such, a fixing point between the support member 12 and the vehicle body 2 may be located at the center section along the length direction of the support member 12, and the support member 12 may cross the upper side and lower side of the fixing point along the longitudinal direction of the vehicle body 2. Therefore, forces on two sides of the fixing point may be balanced, and a displacement phenomenon such as swinging will not occur to the support member 12.

In some embodiments, to increase supporting stability of the support member 12 and strength of the connection structure between the support member 12 and the vehicle body 2, an even number of fixing portions 122 may be included and are arranged symmetrically relative to the support member 12. With the symmetric arrangement of the plurality of fixing portions 122, the weight from the support member 12 may be distributed to different fixing portions 122 more evenly to reliably support and position the support member 12.

In some embodiments, two fixing portions 122 may be included and may be arranged symmetrically on right and left sides of the support member 12. As such, both the fixing portions 122 may be connected to the vehicle body 2. Moreover, since the fixing portions 122 are arranged on two sides of the support member 12, respectively, a gravity center of the two vision sensors 11a and 11b arranged vertically at the support member 12 may be located between both the fixing portions 122. As such, the support member 12 may be reliably supported and positioned, to avoid uneven forces and skewing of the support member 12.

In some embodiments, when the support member 12 is connected to the vehicle body 2 of the UAV by the fixing portions 122, the sensor assembly may further include a fixing member 13. A first through-hole 1221 is arranged at the fixing portion 122. The fixing member 13 passes through the first through-hole 1221 and may be connected to the vehicle body 2 of the UAV to fix the support member 12 at the vehicle body 2.

In some embodiments, the first through-hole 1221 may be along the vertical direction or the horizontal direction. A shape of the fixing member 13 may match a shape and a diameter of the first through-hole 1221. As such, after the fixing member 13 passes through the first through-hole 1221, the fixing member 13, the fixing portion 122, and the vehicle body 2 may be relatively fixed by using cooperation between the fixing member 13 and a hole-surface of the first through-hole 1221 and the connection between the fixing member 13 and the vehicle body 2.

When the fixing member 13 is connected to the vehicle body 2, the fixing member 13 and the vehicle body 2 may be detachably connected through a threaded structure or a snapping connection structure. Thus, the sensor assembly may be conveniently maintained and replaced.

In some embodiments, to prevent the fixing member 13 from falling out from the first through-hole 1221, the fixing member 13 includes a stopper 131 and a connector 132. The connector 132 may be configured to pass through and arranged in the first through-hole 1221 and be connected to the vehicle body 2. The stopper 131 may be configured to stop at an outer end surface of the first through-hole 1221. As such, when the connector 132 and the vehicle body 2 are relatively fixed, the stopper 131 may stop at an outer side of the fixing portion 122 to prevent the fixing member 13 from falling out from the first through-hole 1221.

In some embodiments, to facilitate the connection to the vehicle body 2, the connector 132 may have a rod shape, and an outer surface of the connector 132 may be arranged with a connection thread. Thus, the connector 132 may pass through the first through-hole 1221 and may be connected to the vehicle body 2 by the connection thread. Correspondingly, a threaded hole 21 configured to cooperate with the connector 132, is arranged at the vehicle body 2.

In addition, to form a reliable stop, the stopper 131 may have a lid shape or a pie shape. Thus, a relatively large contact surface may be formed between the stopper 131 and the outer end surface of the first through-hole 1221, and a protrusion dimension of the stopper 131 may be relatively tight.

As the possible fixing manner between the support member 12 and the vehicle body 2, the flexible connector may include the corresponding structure and shape. In some embodiments, the flexible connector may include a flexible sleeve 14. The flexible sleeve 14 may include a second through-hole 141. The flexible sleeve 14 may be arranged in the first through-hole 1221. The second through-hole 141 and the first through-hole 1221 are arranged coaxially. The fixing member 13 may be fixed at the inner side of the flexible sleeve 14 by the second through-hole 141 to cause the flexible sleeve 14 to form the flexible connection between the support member 12 and the fixing member 13.

In some embodiments, the flexible sleeve 14 may be elastic and may be made of a material capable of generating a certain deformation. Therefore, when an external force and vibration are applied to the flexible sleeve 14, the flexible sleeve 14 may absorb or filter the external force or vibration by the deformation of the flexible sleeve 14. When the external force and the vibration are eliminated, the flexible sleeve 14 may restore to an original shape by the elasticity of the flexible sleeve 14. In a fixing manner, the flexible sleeve 14 may be sleeved between the fixing member 13 and the surface of the first through-hole 1221, and the outer surface of the flexible sleeve 14 may be connected to the fixing portion 122 of the support member 12. The hole-surface of the second through-hole 141 of the flexible sleeve 14 may be connected to the fixing member 13. Therefore, the mounting stress from the fixing member 13 and the vibration of the vehicle body 2 may be absorbed by the flexible sleeve 14 sleeved outside the fixing member 13 to reduce the impact on the support member 12.

When the flexible sleeve 14 is arranged in the first through-hole 1221, the flexible sleeve 14 may be positioned along the axial direction of the first through-hole 1221 by friction between the flexible sleeve 14 and the hole-surface of the first through-hole 1221. However, when the UAV is operated for a long time, or a large vibration is generated during the flight of the UAV, the flexible sleeve 14 may slide out of the first through-hole 1221, which may impact the normal flexible connection between the support member 12 and the fixing member 13. In some embodiments, to enhance the positioning of the flexible sleeve 14, a snap slot 1222 may be formed along a radial direction of the first through-hole 1221 and arranged at the fixing portion 122, and a snap protrusion 142 cooperating with the snap slot 1222 may be arranged at the outer surface of the flexible sleeve 14. When the flexible sleeve 14 is arranged in the first through-hole 1221, the snap protrusion 142 may be snapped and arranged in the snap slot 1222.

In some embodiments, since the flexible sleeve 14 may generate the elastic deformation, the flexible sleeve 14 may be easily mounted in the first through-hole 1221, and the snap protrusion 142 at the outer surface of the flexible sleeve 14 may be snapped in the snap slot 1222. As such, the fixing portion 122 may fix the flexible sleeve 14 in the axial direction by the snap slot 1222.

Snap slots 1222 and snap protrusions 142 may include a plurality of quantities and shapes. For example, one or more snap slots 1222 may be included and may be arranged on opposite sides of the fixing portion 122 or along the axial direction of the first through-hole 1221 at intervals. The snap protrusion 142 may include a protrusion, an elastic snap claw, etc., protruding along the radial direction of the first through-hole 1221. In some other embodiments, the snap slot 1222 and the snap protrusion 142 may be in other quantities and have other shapes, which are not repeated here.

In some embodiments, the flexible sleeve 14 or other flexible connectors may be an integral member made of the flexible material. For example, the flexible connector may be a silicone member. Silicone may have good elasticity and recovery ability, and also have good chemical stability and corrosion resistance. Thus, the silicone may adapt to an operating environment of the UAV to form the reliable flexible connection between the support member 12 and the vehicle body 2 of the UAV.

In addition, when the support member 12 is fixed at the vehicle body 2, a certain moving gap may be retained. As such, when being impacted by the external force, the support member 12 may move as a whole, and a relatively large deformation may not be caused for a suspended part relative to a fixed part.

In the sensor assembly, the binocular sensor 1 may only implement the distance measurement task of one direction of the UAV. To realize the detection and distance measurement in other directions of the UAV, other sensors may need to be arranged at the UAV. In some embodiments, to perform the distance measurement operation in other directions, the sensor assembly may further include at least one additional sensor 3, which may be also arranged at the support member 12.

In some embodiments, the sensor assembly further includes sensors 3, which may be configured for the distance measurement task or other detection tasks. Similar to the binocular sensor 1, the sensors 3 may need to include relatively accurate and stable relative positions. Thus, the additional sensors 3 may be arranged at the support member 12. The rigid support member 12 may be configured to stably support and accurately position the sensors 3 to ensure the sensors 3 to realize the detection tasks such as the accurate distance measurement task.

A function of the additional sensors 3 may include but be not limited to performing the distance measurement task. To facilitate the description, the additional sensors 3 may be described as an example of sensors configured for distance measurement.

In some embodiments, to cause the sensor assembly to perform the distance measurement in a plurality of directions, the detection direction of the binocular sensor 1 may point to the front of the sensor assembly, and a detection direction of the additional at least one sensor 3 may be different from the detection direction of the binocular sensor 1. As such, the additional sensors 3 and the binocular sensor 1 may realize the distance measurement tasks in different directions to complete operations of the distance measurement and obstacle avoidance in the plurality of directions during the flight of the UAV.

In some embodiments, to fix the additional sensors 3 at the support member, a second fixing slot 123 may be arranged at the support member 12 to fix the at least one additional sensor 3. The second fixing slot 123 may correspond to the additional at least one sensor 3. A structure and shape of the second fixing slot 123 may match the additional sensor 3 to accommodate and fix the additional sensor 3 in the second fixing slot 123. A number of the second fixing slots 123 may be equal to the number of the additional sensors 3. As such, the additional sensors 3 may be fixed one by one correspondingly in the second fixing slots.

In some embodiments, to perform the detection in different directions, the at least one additional sensor 3 may include at least one of a first sensor 31 pointing to the side of the sensor assembly or a second sensor 32 pointing to the top of the sensor assembly. As such, the additional sensor 3 may perform the detection operation such as the distance measurement toward the side of the sensor assembly and the top of the sensor assembly to form complementary detection areas with the binocular sensor 1, which may point to the front of the sensor assembly, to enlarge the area of the distance measurement and the obstacle avoidance.

In some embodiments, two first sensors 31 may be included. The two first sensors 31 may point to two opposite sides of the sensor assembly. As such, the detection directions of the two first sensors 31 may be arranged oppositely, that is, the two first sensors 31 may perform the detection in two side directions of the sensor assembly to provide a larger distance measurement and obstacle avoidance area. Thus, the two first sensors 31 may cooperate with the binocular sensor 1 to cover a detection area of about 270° of a circumstance of the sensor assembly. In some embodiments, the two first sensors 31 may point to the left and right sides of the sensor assembly, respectively.

In addition, in some embodiments, the first sensors 31 may be arranged at one side of the sensor assembly to perform a single side detection task of the sensor assembly.

In some embodiments, to cause the additional sensor 3 to perform the detection task such as the distance measurement, the additional sensor 3 may include a monocular vision sensor, a binocular sensor, a time of flight (TOF) sensor, etc. The monocular vision sensor and the binocular sensor both may obtain the distance between the sensor assembly and the to-be-detected object through the obtained visual images. A difference between the monocular vision sensor and the binocular sensor may be that the monocular vision sensor may use a change of images of the to-be-detected object when the UAV moves to realize the distance measurement. However, the binocular sensor may use the viewing angle difference between the two different vision sensors to perform the distance measurement. The TOF sensor may use a flight time ranging method to perform the distance measurement. In some embodiments, infrared detection light may be transmitted, while the detection light reflected by the to-be-detected object may be received to obtain the distance to the to-be-detected object. Different types of additional sensor 3 may be selected according to the structural space of the UAV or the user's needs. For example, the first sensor 31 may include the monocular vision sensor or the binocular sensor, and the second sensor 32 may include the TOF sensor.

In some embodiments, the sensor assembly may be applied at the UAV. The sensor assembly may include the binocular sensor. The binocular sensor may include the two vision sensors. The two vision sensors may be located at the same vertical plane and arranged up and down at an interval. As such, the vision sensors may be far away from the structure such as the propeller at the side of the UAV, which may effectively reduce the blocking of the propeller to the viewing angles of the lenses of the vision sensors and ensure the normal photography and the image collection of the vision sensors.

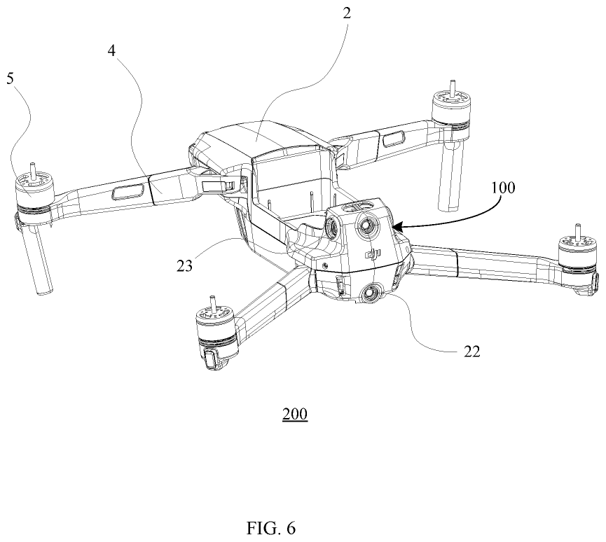

FIG. 6 is a schematic structural diagram of a UAV 200 according to some embodiments of the present disclosure. As shown in FIG. 6, the UAV 200 consistent with embodiments of the present disclosure includes the vehicle body 2, and the sensor assembly 100 arranged in the vehicle body 2. The structure, function, and working principle of the sensor assembly 100 are described in detail above and are not repeated here.

In some embodiments, besides the vehicle body 2, the UAV 200 further includes a vehicle arm 4 and a power assembly 5 arranged at the vehicle arm 4. The sensor assembly 100 is arranged at the vehicle body 2. The binocular sensor of the sensor assembly 100 may perform the detection task such as the distance measurement to ensure the UAV 200 to take off or land normally and safely.

A gimbal and a camera assembly may be arranged at the front end of the vehicle body 2 of the UAV 200. In some embodiments, the sensor assembly 100 may be located at the rear end of the vehicle body 2, As such, the sensor assembly 200 may be mainly configured to perform the detection task such as the distance measurement behind the UAV 200 to cause the UAV 200 to realize a flight operation such as the obstacle avoidance in the rear smoothly.

Since the UAV 200 as a whole is usually distributed symmetrically left and right, the binocular sensor of the sensor assembly 100 may be arranged at the longitudinal symmetry plane of the vehicle body 2. As such, the vertically arranged vision sensors of the binocular sensor may have the same distance to two sides of the UAV 200 (the vehicle arm 4 and the power assembly 5), and the distance may be the maximum distance that can be achieved. Therefore, the blocking of the vehicle arm 4 and the propeller of the power assembly 5 to the viewing angles of the lenses of the vision sensors may be small, which may improve the accuracy and reliability of the distance measurement.

In some embodiments, to accommodate the sensor assembly 100 and cause the sensor assembly to work normally, the vehicle body 2 of the UAV may include a chamber, which may be configured to accommodate the sensor assembly 100. A first lens hole 22 connecting both inner and outer sides of the chamber may be arranged at the housing of the chamber. The first lens hole 22 may match the binocular sensor 1 of the sensor assembly 100. Then, the whole sensor assembly 100 may be protected by the vehicle body 2, and external light may enter the binocular sensor of the sensor assembly 100 through the first lens hole 22. Thus, the binocular sensor may perform the normal image collection.

In addition, when the sensor assembly 100 further includes the at least one additional sensor, to cause the additional sensor to work normally, a second lens hole 23, which connects both the inner and outer sides of the chamber and matches the at least one additional sensor, may be arranged at the vehicle body 2. Then, the additional sensor may perform the detection task through the second lens hole 23. A position and a size of the second lens hole 23 may match a position and a size of a detection end of the additional sensor.

To further improve the safety and reliability of the flight of the UAV 200 or complete other detection tasks, the UAV 200 may further include a binocular sensor arranged at the front of the vehicle body 2, a binocular sensor arranged at the bottom of the vehicle body, an ultrasound sensor, an infrared sensor, etc. The binocular sensor being arranged at the front of the vehicle body 2, the binocular sensor being arranged at the bottom of the vehicle body, the ultrasound sensor, and the infrared sensor may be used simultaneously or may be selectively installed and used.

In some embodiments, the UAV may include the vehicle body and the sensor assembly arranged inside the vehicle body. The sensor assembly may include the binocular sensor. The binocular sensor may include two vision sensors. The two vision sensors may be located at the same vertical plane and arranged up and down at an interval. As such, the vision sensors may be far away from the structures such as the propellers at the side of the UAV. The blocking of the propellers to the viewing angles of the lenses of the vision sensors may be effectively reduced. Thus, the normal photographing and the image collection of the vision sensors may be ensured.

In summary, above embodiments are only used to illustrate the technical solutions of the present disclosure, but not to limit the present disclosure. Although the present disclosure is described in detail with reference to above-described embodiments, those of ordinary skill in the art should understand that modifications may still be made to the technical solutions described in above-described embodiments, or equivalent replacements may still be made to some or all of the technical features. These modifications or replacements do not make the essence of the corresponding technical solutions depart from the scope of the technical solutions of embodiments of the present disclosure.

What is claimed is:

1. A sensor assembly for an unmanned aerial vehicle (UAV) comprising:
a binocular sensor including two vision sensors, wherein:
the two vision sensors are located at a same vertical plane; and
the two vision sensors are arranged one above another at an interval.

2. The sensor assembly of claim 1, wherein the two vision sensors are located at a longitudinal symmetry plane of the UAV.

3. The sensor assembly of claim 2, wherein the two vision sensors face a same direction.

4. The sensor assembly of claim 3, wherein optical axes of the two vision sensors are parallel to each other.

5. The sensor assembly of claim 1, wherein an angle exists between a horizontal plane and an optical centerline connecting optical centers of the two vision sensors.

6. The sensor assembly of claim 5, wherein the optical centerline is perpendicular to the horizontal plane.

7. The sensor assembly of claim 1, further comprising:
a support member arranged at the UAV and configured to fix the vision sensors.

8. The sensor assembly of claim 7, wherein the support member is flexibly connected to a vehicle body of the UAV.

9. The sensor assembly of claim 8, further comprising:
a flexible connector connected between the support member and the vehicle body of the UAV.

10. The sensor assembly of claim 9, wherein:
the support member includes a fixing portion configured to be connected to the vehicle body of the UAV via the flexible connector.

11. The sensor assembly of claim 10, wherein:
the two vision sensors are arranged at two ends of the support member, respectively; and
the fixing portion is located at a center section of the support member.

12. The sensor assembly of claim 10, further comprising:
a fixing member;
wherein the fixing portion includes a through-hole configured to allow the fixing member to pass through to be connected to the vehicle body of the UAV to fix the support member at the vehicle body.

13. The sensor assembly of claim 12, wherein the fixing member includes:
a connector passing through the through-hole and being fixed to the vehicle body; and
a stopper stopping at an outer end surface of the through-hole.

14. The sensor assembly of claim 13, wherein:
the connector has a rod shape; and
a connection thread is provided at an outer surface of the connector.

15. The sensor assembly of claim 12, wherein:
the through-hole is a first through-hole;
the flexible connector includes a flexible sleeve including a second through-hole;
the flexible sleeve is arranged in the first through-hole;
the second through-hole and the first through-hole are coaxially arranged; and
the fixing member is fixed at an inner side of the flexible sleeve via the second through-hole to cause the flexible sleeve to form a flexible connection between the support member and the fixing member.

16. The sensor assembly of claim 15, wherein:
a snap slot formed along a radial direction of the first through-hole is arranged at the fixing portion;
a snap protrusion cooperating with the snap slot is arranged at an outer surface of the flexible sleeve; and
when the flexible sleeve is arranged in the first through-hole, the snap protrusion is snapped in the snap slot.

17. The sensor assembly of claim 10, wherein the fixing portion is one of an even number of fixing portions of the support member, the fixing portions being arranged symmetrically relative to the support member.

18. The sensor assembly of claim 17, wherein the even number of fixing portions include two fixing portions arranged symmetrically on left and right sides of the support member.

19. The sensor assembly of claim 9, wherein the flexible connector includes a silicone member.

20. The sensor assembly of claim 7, wherein the support member includes fixing slots configured to fix the vision sensors.

21. The sensor assembly of claim 7, further comprising:
at least one additional sensor arranged at the support member.

22. The sensor assembly of claim 21, wherein:
a detection direction of the binocular sensor points to front of the sensor assembly; and
a detection direction of the at least one additional sensor is different from the detection direction of the binocular sensor.

23. The sensor assembly of claim 21, wherein the support member includes a fixing slot corresponding to and configured to fix the at least one additional sensor.

24. The sensor assembly of claim 21, wherein the at least one additional sensor includes at least one of a first sensor pointing to a side of the sensor assembly or a second sensor pointing to a top of the sensor assembly.

25. The sensor assembly of claim 24, wherein the first sensor is one of two first sensors of the sensor assembly pointing to two opposite sides of the sensor assembly, respectively.

26. The sensor assembly of claim 25, wherein the two first sensors point to left and right sides of the sensor assembly, respectively.

27. The sensor assembly of claim 21, wherein the at least one additional sensor includes a monocular vision sensor, a binocular sensor, or a time of flight (TOF) sensor.
